(19) United States
(12) Patent Application Publication
(10) Pub. No.: US 2003/0225793 A1
(43) Pub. Date: Dec. 4, 2003

(54) System and method for transferring and managing data files using initialization parameter files

(75) Inventor: Mrinal Chakraborty, Richmond, VA (US)

Correspondence Address: Finnegan, Henderson, Farabow, Garrett & Dunner, L.L.P., 1300 I Street, N.W., Washington, DC, 20005-3315, US

(73) Assignee: Capital One Financial Corporation

(21) Appl. No.: 10/156,818

(22) Filed: May 30, 2002

(51) Int. Cl. G06F 17/30

(52) U.S. Cl. 707/200

(57) ABSTRACT

Methods and systems for transferring and managing data files from a source system using initialization parameter files are disclosed. A server receives an indication from the source system that a data file is available for transfer. Based on the indication, the server selects an entry for the data file in a first initialization parameter. The server then acquires a plurality of parameters from the selected entry and retrieves the data file from the source system according to a processing strategy based on the parameters.

### FIELD OF THE INVENTION

The present invention generally relates to data processing systems and, more particularly, to systems and methods for transferring and managing data files using initialization parameter files.

### BACKGROUND AND MATERIAL INFORMATION

File transfer protocol (FTP) is a protocol used for copying files to and from remote computer systems on a network. The protocol also allows users to use FTP commands to work with files, such as listing files and directories on the remote system. A typical FTP system includes a FTP server and at least one FTP client. The FTP server may include a server protocol interpreter (PI) and a server data transfer process (DTP). The FTP client may include a user interface, a user PI, and a user DTP.

The user PI initiates a control connection between itself and the server PI. At the initiation of the user, standard FTP commands are generated by the user PI and transmitted to the server PI via the control connection. The server PI may send, to the user PI, standard replies to the commands over the control connection. FTP commands specify the parameters for the data connection (e.g., data port, transfer mode, representation type, and structure) and the nature of file system operation (e.g., store, retrieve, append, delete, etc.). The user DTP may listen on the specified data port, and the server DTP may initiate the data connection and data transfer in accordance with the specified parameters.

A FTP system may be configured so that a server periodically retrieves data files using an FTP transfer from one or more source systems. In such a configuration, the server needs to be programmed with code telling it what data files to retrieve, when to retrieve the files, where to retrieve the files, etc. In order to alter the retrieval process, that code must be modified. This code modification typically requires a large development time. Accordingly, there is a need for a system and method for changing the specifics of data file transfer without modifying the code associate with an FTP engine.

### SUMMARY OF THE INVENTION

Methods and systems consistent with the principles of the invention manage data files received from a source system. A server receives an indication from the source system that a data file is available for transfer. Based on the indication, the server selects an entry for the data file in a first initialization parameter. The server then acquires a plurality of parameters from the selected entry and retrieves the data file from the source system according to a processing strategy based on the parameters.

Methods and systems consistent with the principles of the invention also manage data files transferred from a source system using a first initialization parameter file and a second initialization parameter file. A server reads an entry corresponding to a data file from the second initialization parameter file and determines whether the source system is expected to create the data file based on parameters from the entry. The server then watches for the data file from the source system based on the determination. The server also receives an indication from the source system that a data file is available for transfer. Based on the indication, the server selects an entry for the data file in a first initialization parameter. Thereafter, the server then acquires a plurality of parameters from the selected entry and retrieves the data file from the source system according to a processing strategy based on the parameters from the selected entry.

Other methods and systems consistent with the principles of the invention also manage data files received from a source system. A server receives an indication from the source system that a data file is available for transfer. Based on the indication, the server selects an entry for the data file in a first initialization parameter. The server then acquires a plurality of parameters from the selected entry and retrieves the data file from the source system according to a processing strategy based on the parameters. After retrieving the data file, the server requests to save the retrieved data file in a global list file and accesses the global list file to save the retrieved data file. The server further determines whether all of the data files needed to execute a job are available in the global list file, provides the needed data files to the job once the needed data files are available, and executes the job.

Other methods and systems consistent with the principles of the invention also manage data files received from a source system. A server receives a signal file from the source system indicating that a data file is available for transfer. Based on the contents of the signal file, the server selects an entry for the data file in a first initialization parameter. The server then acquires a plurality of parameters from the selected entry and retrieves the data file from the source system according to a processing strategy based on the parameters. After retrieving the data file, the server requests to save the retrieved data file in a global list file.

Both the foregoing general description and the following detailed description are exemplary and are intended to provide further explanation of the embodiments of the invention as claimed.

### BRIEF DESCRIPTION OF THE DRAWINGS

The accompanying drawings are incorporated in and constitute a part of this specification and, together with the description, explain the features and principles of the invention. In the drawings:

FIG. 1 is a diagram of an exemplary network environment for implementing features and aspects consistent with the present invention;

FIG. 2 is an exemplary diagram of a server consistent with the present invention;

FIG. 3 is an exemplary diagram of a source system consistent with the present invention;

FIG. 4 is an exemplary diagram of a signal file consistent with the present invention;

FIG. 5 is an exemplary diagram of an entry in a first initialization parameter file consistent with the present invention;

FIG. 6 is an exemplary diagram of an entry in a second initialization parameter file consistent with the present invention;

FIG. 7 is an exemplary flowchart of a method for retrieving a data file from a source system in a manner consistent with the present invention;

FIG. 8 is an exemplary flowchart of a method for checking for the arrival of data files from a source system in a manner consistent with the present invention; and

FIG. 9 is an exemplary dataflow diagram of a global manager in a manner consistent with the present invention.

### DETAILED DESCRIPTION

The following detailed description of the invention refers to the accompanying drawings. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

### Overview

Methods and systems consistent with the principles of the invention transfer and manage data files using first and second initialization parameters files. A server is operable to read, from a second initialization parameter file, an entry corresponding to a data file and determine whether one of a plurality of source systems is expected to create the data file based on parameters read from the entry. In response, the server watches for the corresponding data file from a source system. While watching for the data file, the server may receive an indication from the source system that the data file is available for transfer. Thereafter, the server selects an entry in a first initialization parameter file based on the indication, acquires a plurality of parameters from the selected entry, and retrieves the data file from the source system according to a strategy based on the parameters from the selected entry.

A global manager located at the server may receive a request to save the retrieved data file in a global list file, then access the global list file to save the retrieved data file. When a job desires to run, the global manager determines whether all of the data files needed to execute a job are available in the global list file and provides the needed data files to the job once the needed data files are available. The job may then be executed.

### System Environment

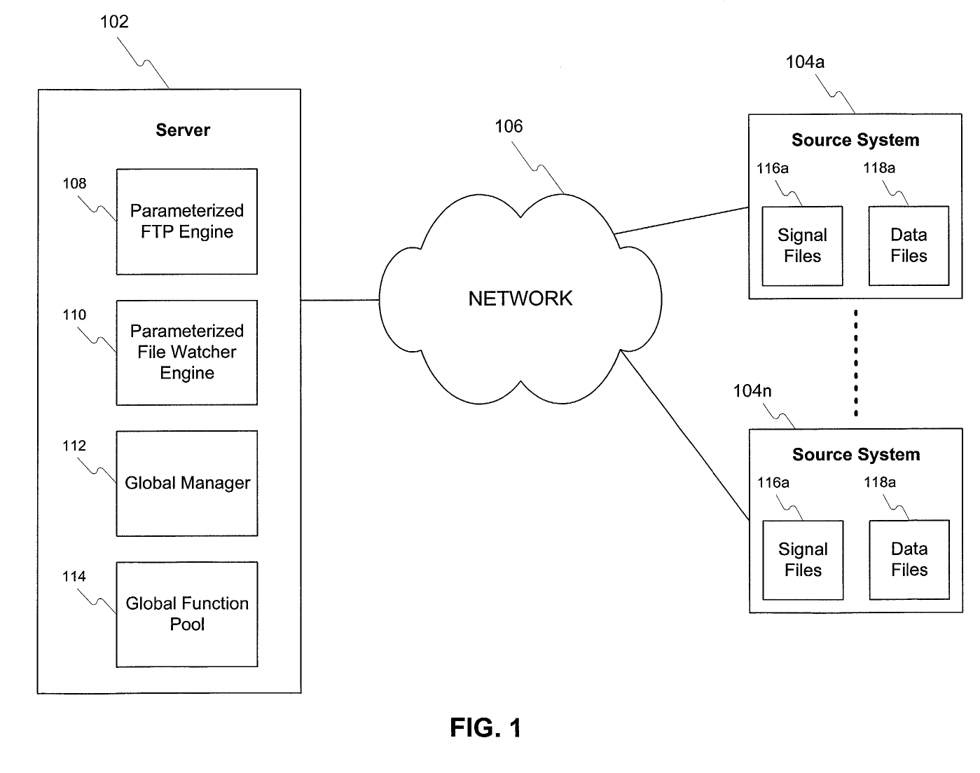

FIG. 1 is a diagram of an exemplary network environment 100 in which the features and aspects of the present invention may be implemented. Network environment 100 includes server 102, source systems 104A through 104N, and network 106. The components of FIG. 1 may be implemented through hardware, software, and/or firmware. The number of components in network environment 100 is not limited to what is shown.

Server 102 may include parameterized FTP engine 108, parameterized file watcher engine 110, global manager 112, and global function pool 114. Parameterized FTP engine 108 controls file transfers between server 102 and source systems 104a-104n. Parameterized FTP engine 108 wakes up at regular intervals to perform pending transfers. A source system, such as source system 104a, sends a signal file to parameterized FTP engine 108. In response, parameterized FTP engine 108 accesses a corresponding entry in a first initialization parameter file (IPF) and uses information from the entry to determine an FTP strategy. One of skill in the art will recognize that multiple servers similar to server 102 may exist in network environment 100.

Parameterized file watcher engine 110 checks for the arrival of data files from a source system. File watcher engine 110 performs the check based on parameters from a second initialization parameter file IPF). For example, based on the second IPF, parameterized file watcher engine 110 may determine whether a source system is going to create the file on a given day. If not, then there is no need to watch for the data file. Parameterized file watcher 110 also determines how frequently a data file should be checked for, and how long a data file should be looked for, before contacting an administrator.

Global manager 112 manages unprocessed data files of all jobs in a single global list instead of maintaining a list of unprocessed data files for each job. Global manager 112 uses the second IPF to determine which data files are required to run a job. Global manager 112 also aids jobs in catching up from multiple days of backlogs by processing data files in FIFO (first in first out) order.

Parameterized FTP engine 108, parameterized file watcher engine 110, and global manager 112 may all use functions and procedures stored in a central location, such as global function pool 114. Global function pool 114 is a repository of frequently used functions and procedures. Alternatively, parameterized FTP engine 108, parameterized file watcher engine 110, and global manager 112 may use functions stored local to their respective units.

Source systems 104a-104n may be systems from various parts of the same or different business entities, each having data files of interest to server 102. For example, one source system may be from the marketing department of a company, while another source system may be from the sales department of that company. Server 102 may require data files from the source systems to analyze them or otherwise process them. For example, server 102 may analyze data files received from source systems 104a-104n to determine how well respective departments that correspond to the source systems are doing. Each source system 104 may include a number of signal files 116 and a number of data files 118. Signal files 116 may be used by a source system 104 to inform server 102 that a data file is ready to be transferred from the source system to the server. In response, a parameterized FTP engine from the server 102 determines an appropriate FTP strategy based on the signal file and an entry in a first IPF file. Thereafter, one of the data files from data files 118 is appropriately transferred.

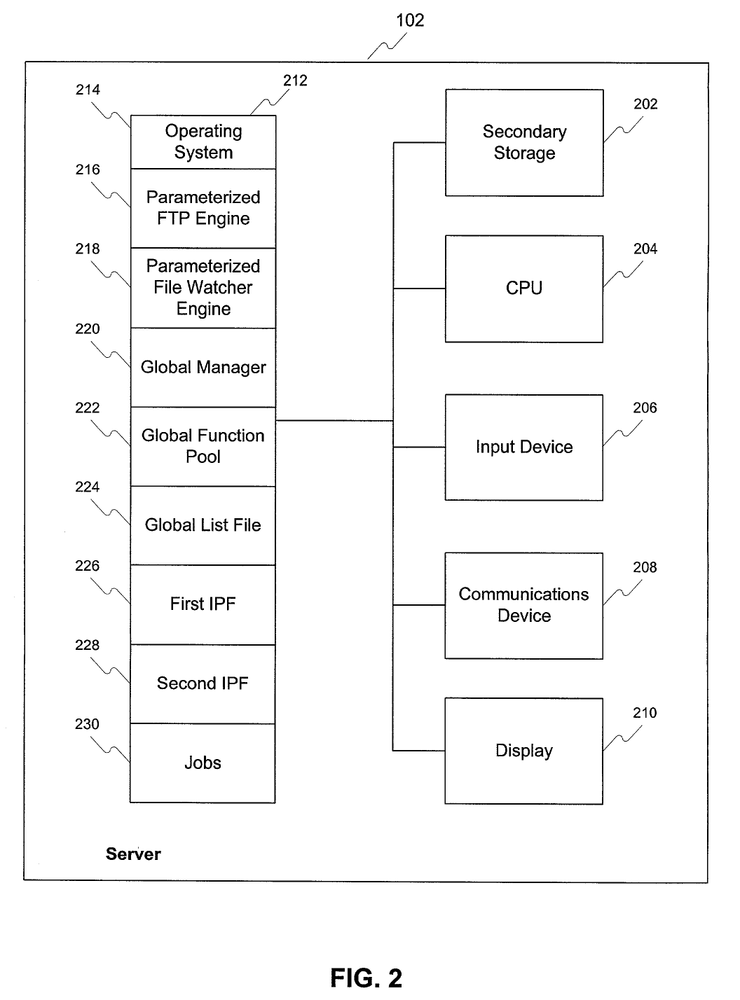

FIG. 2 is an exemplary diagram of a server consistent with the present invention. Server 102 may include secondary storage 202, CPU 204, input device 206, communications device 208, display 210, and memory 212. Memory 212 may include operating system 214, parameterized FTP engine 216, parameterized file watcher engine 218, global manager 220, global function pool 222, global list file 224, first IPF 226, second IPF 228, and jobs 230.

Operating system 214 may be an operating system such as Unix or any other operating system for implementing FTP file transfers. Parameterized FTP engine 216, parameterized file watcher engine 218, global manager 220, and global function pool 222 all operate in a manner consistent with the description of these units provided with reference to FIG. 1 above. Global list file 224 stores a list of unprocessed data files in FIFO order. An unprocessed data file is a data file that has not yet been used in association with a job. Data files in global list file 224 may be files that were transferred from a source system 104 to server 102. In other words, data files may be stored in global list file 224 soon after being transferred from a source system 104. Global list file 224 may also store data files that are generated as the result of job processing. Global manager 220 controls access to global list file 224.

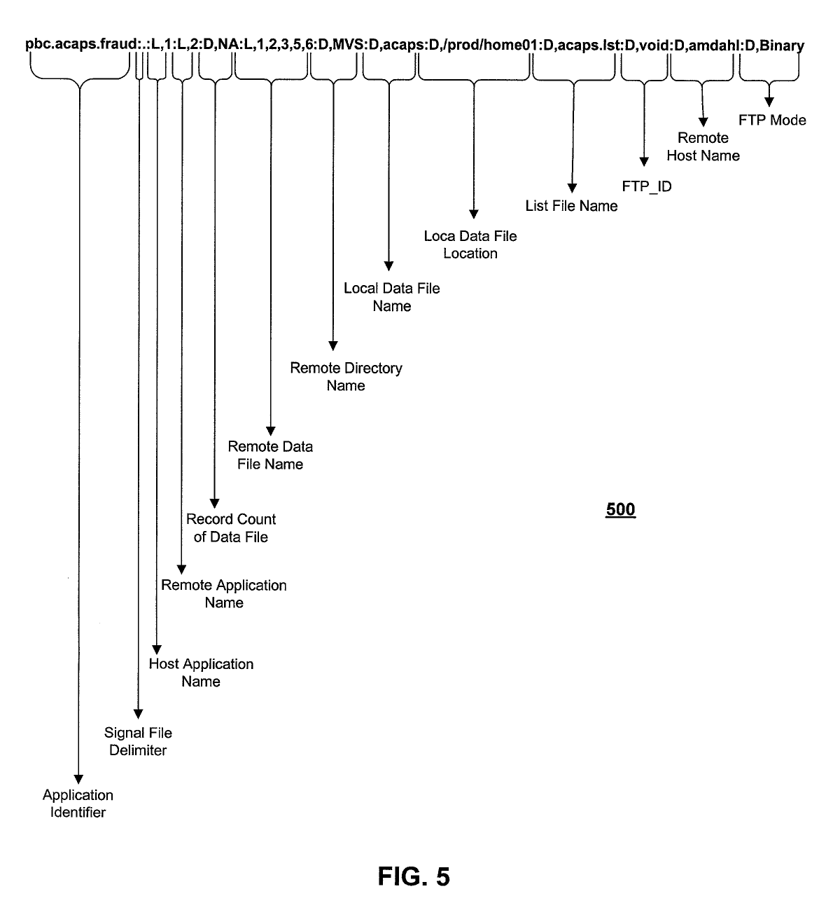

First IPF 226 comprises multiple entries that determine the FTP strategy for file transfers between source systems 104 and server 102. An entry in the first IPF 226 may include an application identifier, a signal file delimiter, a host application name, a remote application name, a record count of data file, a remote data file name, a remote directory name, a local data file name, a local data file location, a list file name, an FTP identification, and an FTP mode. More detail on these pieces of information is provided below with reference to FIG. 5.

By using a first IPF to help determine FTP strategy, modifying the FTP behavior of the system is greatly simplified. For example, adding or removing a source system is simply a matter of modifying the first IPF instead of modifying the code of a FTP engine itself or other similar unit for controlling FTP transfer. Another effect is that the code size of an FTP engine may also remain substantially the same.

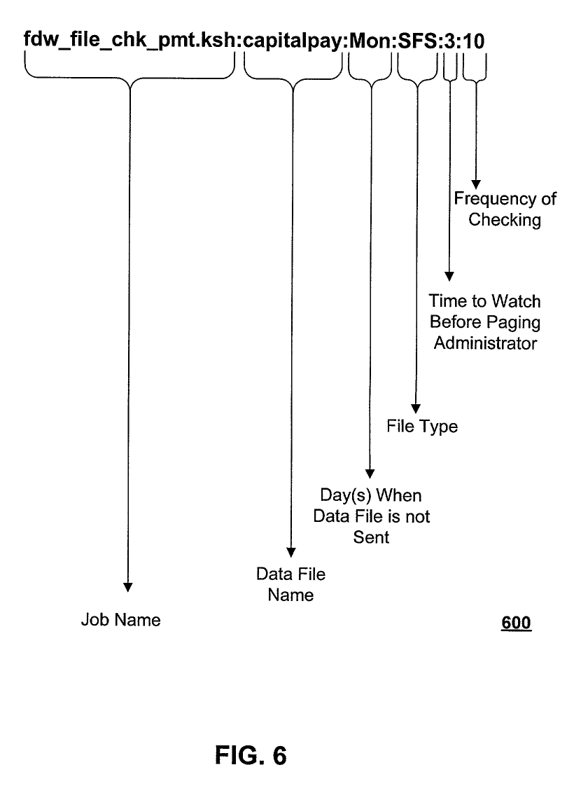

Second IPF 228 comprises multiple entries for use by parameter file watcher engine 218 to determine strategies for checking for particular data files. Global manager 220 may also use second IPF 228 to determine the specific files that are required to run a particular job. An entry in the second IPF 228 may include a job name, an input data file name, an indication of when (e.g., a particular day) the data file is not sent, an indication of when (e.g., which hours) file watcher engine 218 must watch for the data file before paging the administrator, and the frequency of checking for the data file. More detail on these pieces of information is provided below with reference to FIG. 6.

Jobs 230 may be processes that are executed by server 102. Jobs 230 may require one or more data files to properly execute. These data files may include data files received from source systems 104 during an FTP transfer. Global manager 220 may maintain a list of unprocessed data files in global list file 224 in FIFO order. Before starting a job 230, the job submits a request to global manager 220 to check whether all of the input data files required for execution of the job are available. Once global manager 220 has acknowledged that all of the data files are available, job 230 may submit a request to get all of the needed data files from global list file 224. After job 230 has been successfully completed, it may write an output file it created to global list file 224 by submitting a global list write request to global manager 220.

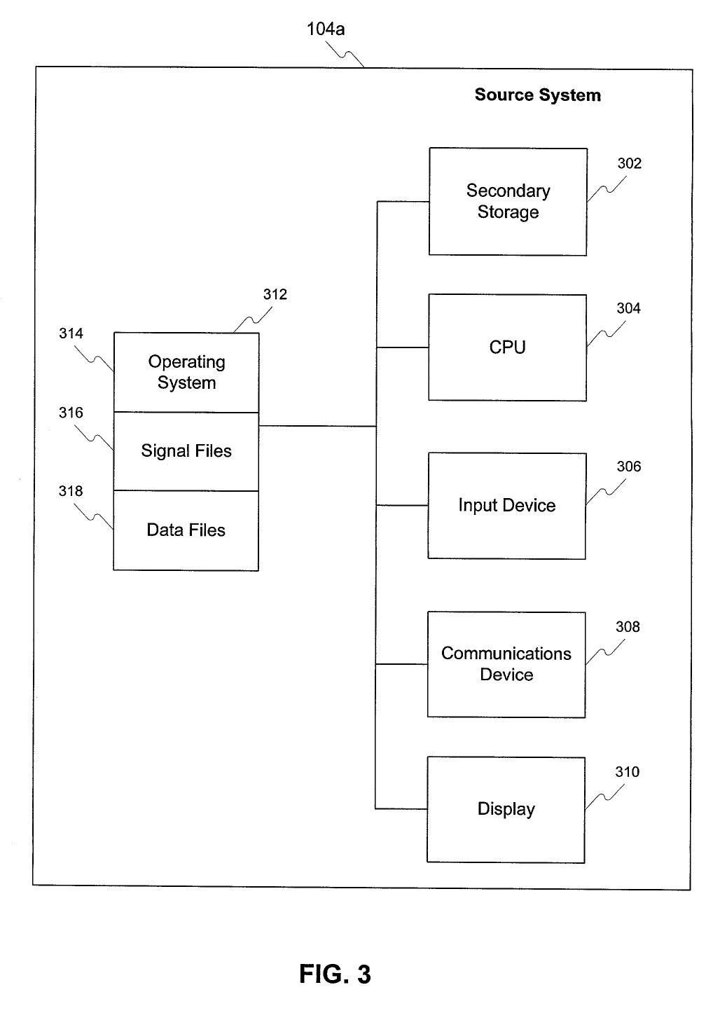

FIG. 3 is an exemplary diagram of a source system consistent with the present invention. A source system, such as source system 104a, may include secondary storage 302, CPU 304, input device 306, communications device 308, display 310, and memory 312. Memory 312 may include operating system 314, signal files 316, and data files 318.

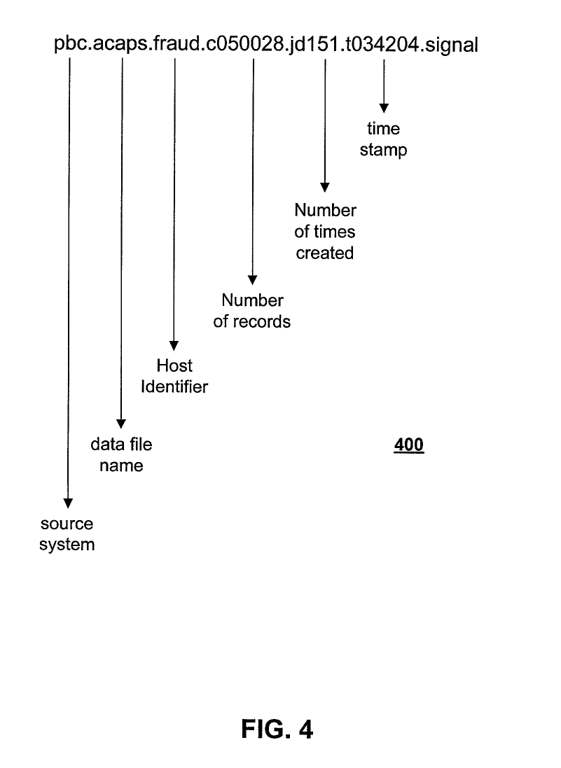

Operating system 314 may be an operating system such as Unix or any other operating system for implementing FTP file transfers. Signal files 316 may include a number of files used by source system 104a to signal to server 102 that a particular data file is available for FTP transfer. A signal file from signal files 316 may include information such as a source system identifier, an application identifier, a host identifier, a number of records in the associated data file, a number of times the data file has been created, or the time of day that signal file was created. More detail on these pieces of information is provided below with reference to FIG. 4.

Data files 318 comprise a number of data files that may be transferred to server 102 during an FTP transfer. Each data file in data files 318 may have an associated signal file from signal files 318. Source systems 104 may create a signal file that corresponds to a data file when the data file is created.

FIG. 4 is an exemplary diagram of a signal file consistent with the present invention. A signal file 400 is an exemplary signal file from signal files 316 and may include several parameters each separated by a period or other delimiter. For example, signal file 400 may comprise seven parameters. In the example illustrated in FIG. 4, the parameter “pbc” identifies a source system. The parameter “acaps” identifies a data file (e.g., a data file in data files 318). The parameter “fraud” identifies a host (e.g., server 102) that receives signal file 400.

The parameter “c050028” refers to the number of records in the data file associated with signal file 400. For this example, the data file “acaps” has 50,028 records in it. The parameter “jd151” indicates that the data file “acaps” has been created 151 times so far. The parameter “t034204” indicates the specific time that the signal file and corresponding data file were created. The parameter “signal” indicates that signal file 400 is a signal file.

FIG. 5 is an exemplary diagram of an entry in a first initialization parameter file 226 consistent with the present invention. First IPF 226 typically comprises a number of such entries, each corresponding to a data file received from a source system. As shown in FIG. 5, entry 500 may comprise a number of parameters each separated by colons. Specifically, entry 500 may include an application identifier, a signal file delimiter, a host application name, a remote application name, a record count of data file, a remote data file name, a remote directory name, a local data file name, a local data file location, a list file name, an FTP identification, or an FTP mode. In the example illustrated in FIG. 5, the parameter “pbc.acaps.fraud” identifies the application identifier. The application identifier corresponds to the first three parameters of a signal file and is used in conjunction with the signal file to look up particular entries in the first IPF 226. Signal file delimiter indicates a symbol used to separate parameters in a signal file (e.g., signal file 400). Host application name refers to a host (e.g., server 102) that receives the signal file and data file referenced by entry 500. Remote application name refers to the source system 104 associated with the data file referenced by entry 500. Record count of data file indicates the number of records in a data file. Remote data file name refers to the name of the data file as stored on the source system. Remote directory name refers to the name of the directory where the data file is located on the source system.

Local data file name refers to the name of the transferred data file on the server. Local data file location refers to the location of the transferred data file on the server (e.g., host). List file name refers to the name used to store the transferred data file in the global list file. FTP identification refers to an identification tag to be used during FTP transfer. The identification tag may be referred to as an FTP login name. Remote host name refers to the name of a computer located at the source system. FTP mode refers to the type of FTP transfer to be used. In one embodiment, FTP mode may be either ASCII or binary.

FIG. 6 is an exemplary diagram of an entry in a second initialization parameter file 228 consistent with the present invention. Second IPF 228 typically comprises a number of such entries. As shown in FIG. 6, entry 600 may comprise a number of parameters, each separated by colons. Specifically, entry 600 may include a job name, an input data file name, an indication when (e.g., the particular day(s)) the data file is not sent, a file type, a number of hours that file watcher engine 218 must watch for the data file before paging the administrator, or the frequency of checking for the data file. In the example illustrated in FIG. 6, the parameter “fdw_file_chk_pmt.ksh” identifies a job name. The parameter “capitalpay” identifies the name of a data file that is used by “fdw_file_chk_pmt.ksh.” The parameter “Mon” indicates that the data file “capitalpay” is not sent on Mondays. As such, parameterized file watcher engine 218 will not look for “capitalpay” on Mondays.

The parameter “SFS” indicates that the file type is a single file system. An alternative to single file system is a multiple file system (MFS). To process faster, a data file may be divided into any number of parts. Each part may be processed in parallel, and the output is obtained from each parallel process to finalize the job. A data file before partition may be called an SFS file. If a data file is partitioned into four parts, for example, it may be called a 4-way MFS file. If a data file is partitioned into eight parts, it may be called an 8-way MFS file, an so on.

The parameter “3” indicates that parameterized file watcher engine 218 should watch for the file “capitalpay” for three hours before automatically notifying the administrator. The parameter “10” indicates that within the three hour time frame set forth by the parameter “3,” parameterized file watcher engine 218 should watch for the data file at ten minutes intervals. In other words, file watcher engine 218 needs to check for the file once every ten minutes for three hours. If the file is not available for transfer within that time frame, the administrator will be automatically paged.

### System Operation

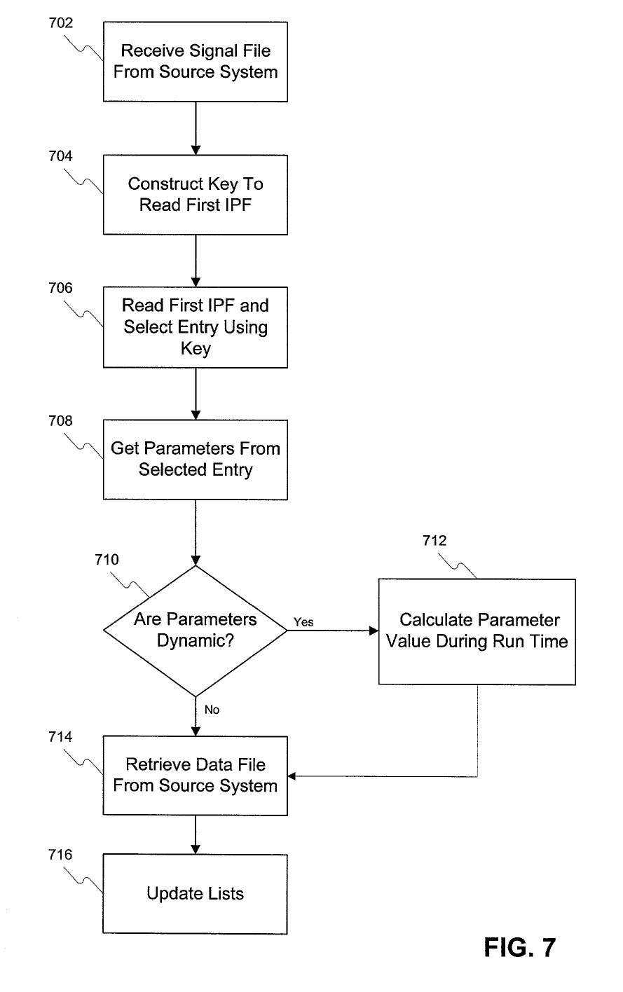

FIG. 7 is an exemplary flowchart of a method for retrieving a data file from a source system in a manner consistent with the present invention. Although the steps of the flow chart are described in a particular order, one skilled in the art will appreciate that these steps may be performed in a different order, or that some of these steps may be concurrent.

First, parameterized FTP engine 216 receives a signal file from a source system 104 (step 702). Receipt of the signal file indicates that a data file that corresponding to the signal file is ready for transfer from the source system. In response to receiving the signal file, parameterized FTP engine 216 may construct a key from the signal file to read the first IPF 226 (step 704). For example, using signal file 400, parameterized FTP engine 216 may take the first three fields, “pbc.acaps.fraud” and use it to lookup an entry in first IPF 226. Once parameterized FTP engine 216 has constructed a suitable key, it may read first IPF 226 and select a corresponding or matching entry (step 706). So if parameterized FTP engine 216 uses “pbc.acaps.fraud” as a key to first IPF 226, an entry 500 of first IPF 226 may be the result because it has “pbc.acaps.fraud” as an application identifier parameter.

After finding the correct entry, parameterized FTP engine 216 retrieves the parameters from that entry (step 708). These parameters may include an application identifier, a signal file delimiter, a host application name, a remote application name, a record count of data file, a remote data file name, a remote directory name, a local data file name, a local data file location, a list file name, an FTP identification, or an FTP mode.

Because some of the parameters may be dynamic, parameterized FTP engine 216 may determine whether any of the parameters are dynamic (step 710). If there are one or more dynamic parameters in the first IPF entry 500, then parameterized FTP engine 216 may calculate the parameter value during run time (step 712). For example, data files to be transferred may have a particular date and/or time stamp associated with it. In order to properly access the data file, the stamps need to be known. Such stamps are unknown beforehand, so there needs to be a way to dynamically determine them. One way to dynamically determine the date and/or time stamp is to use the date and time stamp from the received signal file. Using the stamp from the signal file, parameterized FTP engine 216 may reconstruct the name of the data file to be transferred from the source system. Other parameters may also be dynamic. For example, the location of a data file may periodically change. As such, a mechanism would be needed to dynamically determine the location from which the data file on the source system should be transferred. Other parameters from an entry in the first IPF 226 may similarly be dynamically determined. Once each dynamic parameter has been determined, parameterized FTP engine 216 may proceed to retrieve the data file from the source system according to the strategy determined by the parameters of the corresponding entry of first IPF 226 (step 714).

If there are no dynamic parameters, then parameterized FTP engine 216 is ready to retrieve the data file from the source system (step 714). During the retrieving, parameterized FTP engine 216 may periodically check for errors in the transfer process. Examples of possible errors may include, for example, invalid FTP identification tag, insufficient access privilege to get data files from source systems, insufficient disk space while transferring files on the server, or record count mismatch. Errors may also be checked for after the transfer is complete. For example, parameterized FTP engine 216 may use the information received from the signal file indicating the number of records in the data file to see whether the number of records actually received during the transfer was correct. If not, then an error has occurred and proper measures can be taken, such as notifying the system administrator. Alternatively, parameterized FTP engine 216 may proceed with receiving data files without checking for errors.

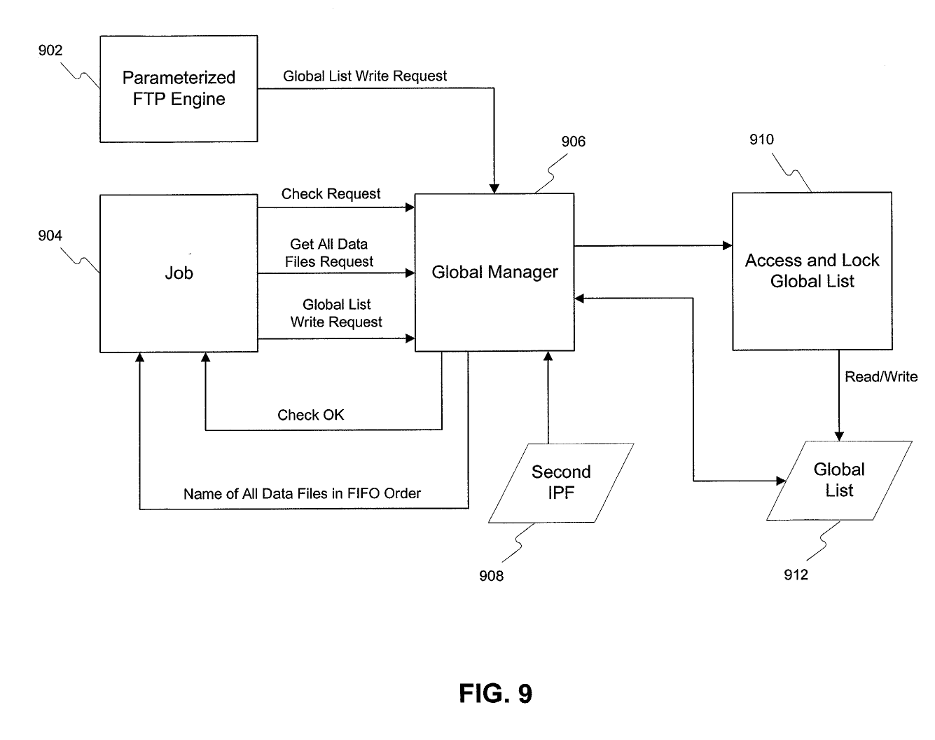

Parameterized FTP engine 216 may also update one or more lists after the data file has been received from the source system (step 716). For example, parameterized FTP engine 108 may send a request to global manager 220 to save the received data file in the global list file 224. Additionally, parameterized FTP engine 216 may save the received data file in a list of recently received data files, and it may save the signal file used to trigger the FTP transfer in an archive signal file directory. Some of the processing of step 716, as well as the processing invoked to execute a job using the retrieved data file, are described in more detail below with respect to FIG. 9.

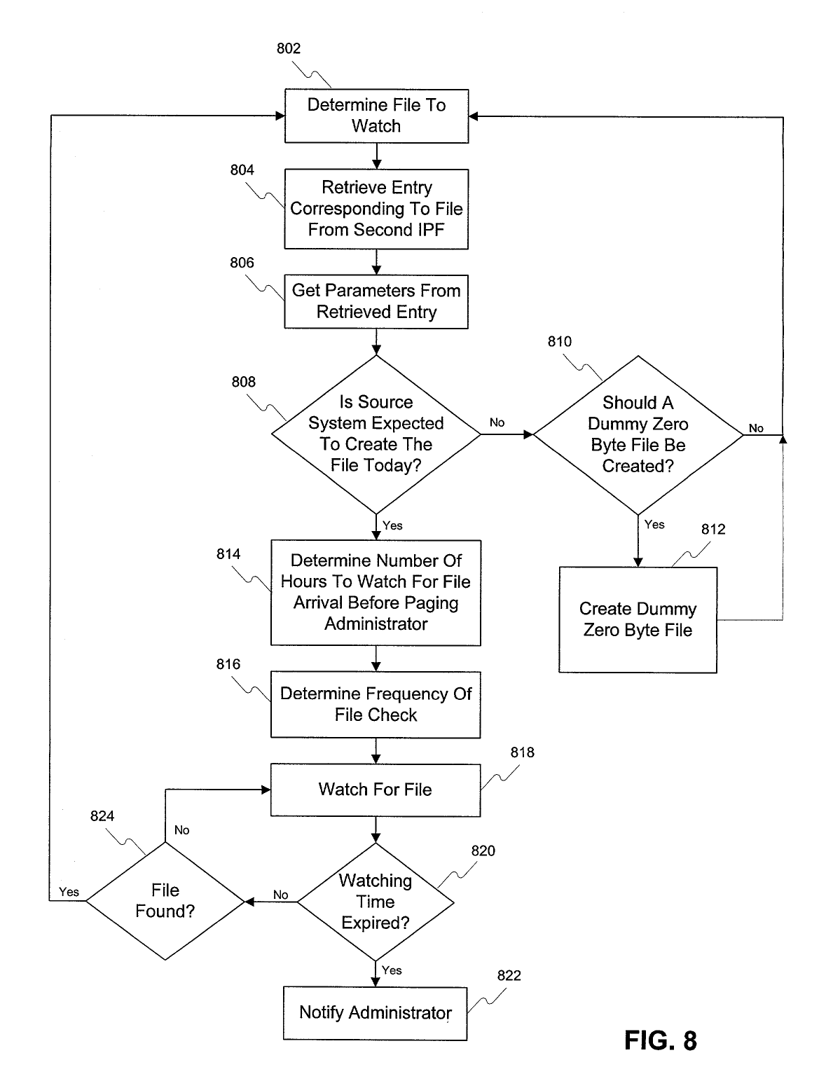

FIG. 8 is an exemplary flowchart of a method for checking for the arrival of data files from a source system in a manner consistent with the present invention. Although the steps of the flow chart are described in a particular order, one skilled in the art will appreciate that these steps may be performed in a different order, or that some of these steps may be concurrent.

On a daily basis, parameterized file watcher engine 218 watches for a number of data files from source systems 104. First, the parameterized file watcher engine 218 determines which data file to watch for from a source system 104 (step 802). This determination may be as simple as going through a list of data files and picking the next data file on the list. For instance, parameterized file watcher engine 218 retrieves an entry corresponding to the data file to be watched from the second IPF 228 (step 804). For the example of FIG. 6, if the data file to be watched is named “capitalpay,” parameterized file watcher engine 218 may retrieve an entry 600 of second IPF 228 because it relates to “capitalpay.”

After retrieving an entry, parameterized file watcher engine 218 may get the parameters associated with that entry (step 806). These parameters may include a job name, an input data file name, an indication of days when the data file is not sent, a file type, a number of hours that file watcher engine 218 must watch for the data file before paging the administrator, or the frequency of checking for the data file. Based on the parameters, a determination may be made as to whether the source system 104 is expected to create the data file today (step 808). If not, then a further determination may be made as to whether a dummy zero byte file be created (step 810). A dummy zero byte file may be created when a job needs to be run despite the fact that a particular data file is not ready. When a job needs to be run in this manner, an empty file with the same name as the source system data file may be created (step 812). The job may then run even though the data file is not available. The empty file is known as a dummy zero byte file.

Regardless of whether a dummy zero byte file is created, parameterized file watcher engine 218 may continue to watch for different data files.

If the source system is expected to create the data file, then parameterized file watcher engine 218 determines the number of hours it needs to watch for file arrival before paging the system administrator (step 814). Parameterized file watcher engine 218 also determines the frequency of checking for file arrival (step 816). Using second IPF entry 600 as an example, upon examining the parameters of second IPF entry 600, parameterized file watcher engine 218 would determine that it should watch for file arrival for a total of three hours before notifying the administrator, checking for file arrival every 10 minutes.

Parameterized file watcher engine 218 may then watch for the data file using the parameters as discussed above in steps 814 and 816 (step 818). While the data file is being watched for, a determination may be made as to whether the total watching time has expired (step 820). If so, then the administrator is automatically notified (step 822). If the time has not expired, then a determination is made as to whether the data file has been received yet (step 824). If not, then parameterized file watcher engine 218 continues to watch for it. Note that although FIG. 8 shows only one data file being watched, parameterized file watcher engine 218 is capable of watching for multiple data file simultaneously.

FIG. 9 is an exemplary dataflow diagram of a global manager in a manner consistent with the present invention. A global manager, such as global manager 220 or 906 may manage unprocessed data files of jobs in a global list file 912. By keeping the data files in FIFO order, global manager 906 also helps jobs catch up on backlogged data files, possibly from multiple days. In managing data files, global manager 906 communicates with various units in server 102 including a parameterized FTP engine, such as parameterized FTP engine 216 or 902.

When parameterized FTP engine 902 receives a data file from a source system (e.g., step 714 of FIG. 7), it may send a request to global manager 906 to write the data file to the global list file 912. Upon receiving this request, global manager 906 may attempt to access global list file 912. More particularly, global manager 906 may first check whether the global list file 912 is locked (e.g., already being accessed). If it is locked, then global manager 906 may wait for a short period of time and again try to access global list file 912. Once global manager 906 determines that global list file 912 is no longer locked, it may proceed to access and lock the global list file (910). Thereafter, global manager 912 may write the data file to the global list file.

Global manager 906 also communicates with various jobs 904. Before starting, every job 904 submits a check request to global manager 906 to determine whether all of the data files associated with the job are available. To make this determination, global manager 906 may access second IPF 908. As described above with respect to FIG. 6, second IPF 908 includes multiple entries, each including various job names and associated data file names. As such, by examining second IPF 908, global manager 906 can determine exactly what data files are required to run job 904. Thereafter, global manager 906 may check global list file 912 to determine whether these data files are available. Global manager 906 may access the global list file by acquiring a lock as previously explained.

Once the global manager 906 has determined that all of the data files required by job 904 are available, it sends a check OK indication back to job 904. In response, job 904 submits a request to global manager 906 to get all of the required data files. After receiving the data files, job 904 proceeds to execute. A number of output data files may be created by the execution of job 904. These data files may need to be used by jobs in the future. So upon successful completion, job 904 submits a request to global manager 906 to write any output data files to the global list file 912. The data file(s) is/are written to the global list file 912 by acquiring a lock as previously explained.

Global manager 906 also aids job 904 in catching up on the processing of backlogged data files. For example, global manager 906 may send job 904 the names of all of the data files associated with that job presently stored in global list file 912. The list of names may be in FIFO order, thereby allowing job 904 to process data files from older days first.

While the present invention has been described in connection with various embodiments, many modifications will be readily apparent to those skilled in the art. One skilled in the art will also appreciate that all or part of the systems and methods consistent with the present invention may be stored on or read from computer-readable media, such as secondary storage devices, like hard disks, floppy disks, and CD-ROM; a carrier wave received from a network such as the Internet; or other forms of ROM or RAM. The invention, therefore is not limited to the disclosure herein, but is intended to cover any adaptations or variations thereof.

What is claimed is:

1. A method for managing data files received from a source system, comprising:
receiving an indication from the source system that a data file is available for transfer;
selecting an entry for the data file in a first initialization parameter file based on the indication;
acquiring a plurality of parameters from the selected entry; and
retrieving the data file from the source system according to a processing strategy based on the parameters.

2. The method of claim 1, wherein the indication is a signal file.

3. The method of claim 2, the selecting comprising:
constructing a key from the signal file;
reading the first initialization parameter file; and
choosing the entry in the first initialization parameter file using the key.

4. The method of claim 1, further comprising:
determining whether any of the parameters are dynamic; and
calculating at least one parameter value during run time based on a determination that at least one parameter is dynamic.

5. The method of claim 1, further comprising:
checking for errors during the retrieving.

6. The method of claim 1, further comprising:
checking for errors after the retrieving.

7. The method of claim 1, further comprising:
sending a request to a global manager to save the retrieved data file in a global list file.

8. The method of claim 1, wherein the entry in the first initialization parameter file includes a listing of processing parameters defining how a server is to process the data file.

9. The method of claim 2, wherein the signal file includes a listing of parameters corresponding to the data file.

10. A method for managing data files transferred from a source system using a first initialization parameter file and a second initialization parameter file, comprising:
reading an entry corresponding to a data file from the second initialization parameter file;
determining whether the source system is expected to create the data file based on parameters from the entry;
watching for the data file from the source system based on the determination;
receiving an indication from the source system that the data file is available for transfer;
selecting an entry in the first initialization parameter file based on the indication;
acquiring a plurality of parameters from the selected entry; and
retrieving the data file from the source system according to a processing strategy based on the parameters from the selected entry.

11. The method of claim 10, further comprising:
creating a dummy file when the source system is not expected to create the data file.

12. The method of claim 10, said watching further comprising:
notifying an administrator when a watching time has expired.

13. The method of claim 10, wherein the entry in the first initialization parameter file includes a listing of processing parameters defining how a server is to process the data file.

14. The method of claim 10, wherein the entry in the second initialization parameter file includes a listing of processing parameters defining how a server is to watch for the data file.

15. A method for managing data files transferred from a source system, comprising:
receiving an indication from the source system that a data file is available for transfer;
selecting an entry for the data file in a first initialization parameter file based on the indication;
acquiring a plurality of parameters from the selected entry;
retrieving the data file from the source system according to a processing strategy based on the parameters;
requesting to save the retrieved data file in a global list file;
accessing the global list file to save the retrieved data file;
determining whether all of the data files needed to execute a job are available in the global list file;
providing the needed data files to the job once the needed data files are available; and
executing the job.

16. The method of claim 15, the accessing comprising:
determining whether the global list file is locked;
acquiring a lock on the global list file based on a determination that the global list file is unlocked; and
saving the retrieved data file in the global list file.

17. The method of claim 15, further comprising:
requesting to save an output data file from the executed job in the global list file; and
accessing the global list file to save the output data file.

18. The method of claim 15, the determining comprising:
examining a second initialization parameter file to determine what files are necessary to execute the job; and
searching the global list files for the files necessary to execute the job.

19. A method for managing data files transferred from a source system, comprising:
receiving a signal file from the source system indicating that a data file is available for transfer;
selecting an entry for the data file in a first initialization parameter file based on contents of the signal file;
acquiring a plurality of parameters from the selected entry;
retrieving the data file from the source system according to a processing strategy based on the parameters; and
sending a request to a global manager to save the retrieved data file in a global list file.

20. An apparatus for managing data files received from a source system, comprising:
means for receiving an indication from the source system that a data file is available for transfer;
means for selecting an entry for the data file in a first initialization parameter file based on the indication;
means for acquiring a plurality of parameters from the selected entry; and
means for retrieving the data file from the source system according to a processing strategy based on the parameters.

21. The apparatus of claim 20, wherein the indication is a signal file.

22. The apparatus of claim 21, the means for selecting comprising:
means for constructing a key from the signal file;
means for reading the first initialization parameter file; and
means for choosing the entry in the first initialization parameter file using the key.

23. The apparatus of claim 20, further comprising:
means for determining whether any of the parameters are dynamic; and
means for calculating at least one parameter value during run time based on a determination that at least one parameter is dynamic.

24. The apparatus of claim 20, further comprising:
means for checking for errors during the retrieving.

25. The apparatus of claim 20, further comprising:
means for checking for errors after the retrieving.

26. The apparatus of claim 20, further comprising:
means for sending a request to a global manager to save the retrieved data file in a global list file.

27. The apparatus of claim 20, wherein the entry in the first initialization parameter file includes a listing of processing parameters defining how a server is to process the data file.

28. The apparatus of claim 21, wherein the signal file includes a listing of parameters corresponding to the data file.

29. An apparatus for managing data files transferred from a source system using a first initialization parameter file and a second initialization parameter file, comprising:
means for reading an entry corresponding to a data file from the second initialization parameter file;
means for determining whether the source system is expected to create the data file based on parameters from the entry;
means for watching for the data file from the source system based on the determination;
means for receiving an indication from the source system that the data file is available for transfer;
means for selecting an entry in the first initialization parameter file based on the indication;
means for acquiring a plurality of parameters from the selected entry; and
means for retrieving the data file from the source system according to a processing strategy based on the parameters from the selected entry.

30. The apparatus of claim 29, further comprising:
means for creating a dummy file when the source system is not expected to create the data file.

31. The apparatus of claim 29, said means for watching further comprising:
means for notifying an administrator when a watching time has expired.

32. The apparatus of claim 29, wherein the entry in the first initialization parameter file includes a listing of processing parameters defining how a server is to process the data file.

33. The apparatus of claim 29, wherein the entry in the second initialization parameter file includes a listing of processing parameters defining how a server is to watch for the data file.

34. An apparatus for managing data files transferred from a source system, comprising:
means for receiving an indication from the source system that a data file is available for transfer;
means for selecting an entry for the data file in a first initialization parameter file based on the indication;
means for acquiring a plurality of parameters from the selected entry;
means for retrieving the data file from the source system according to a processing strategy based on the parameters;
means for requesting to save the retrieved data file in a global list file;
means for accessing the global list file to save the retrieved data file;
means for determining whether all of the data files needed to execute a job are available in the global list file;
means for providing the needed data files to the job once the needed data files are available; and
means for executing the job.

35. The apparatus of claim 34, the means for accessing comprising:
means for determining whether the global list file is locked;
means for acquiring a lock on the global list file based on a determination that the global list file is unlocked; and
means for saving the retrieved data file in the global list file.

36. The apparatus of claim 34, further comprising:
means for requesting to save an output data file from the executed job in the global list file; and
means for accessing the global list file to save the output data file.

37. The apparatus of claim 34, the means for determining comprising:
means for examining a second initialization parameter file to determine what files are necessary to execute the job; and
means for searching the global list files for the files necessary to execute the job.

38. An apparatus for managing data files transferred from a source system, comprising:
means for receiving a signal file from the source system indicating that a data file is available for transfer;
means for selecting an entry for the data file in a first initialization parameter file based on contents of the signal file;
means for acquiring a plurality of parameters from the selected entry;
means for retrieving the data file from the source system according to a processing strategy based on the parameters; and
means for sending a request to a global manager to save the retrieved data file in a global list file.

39. An apparatus for managing data files transferred from a source system, comprising:
a memory having a program that: receives an indication from the source system that a data file is available for transfer; selects an entry for the data file in a first initialization parameter file based on the indication; acquires a plurality of parameters from the selected entry; and retrieves the data file from the source system according to a processing strategy based on the parameters; and
a processor that runs the program.

40. An apparatus for managing data files transferred from a source system using a first initialization parameter file and a second initialization parameter file, comprising:
a memory having a program that: reads an entry corresponding to a data file from the second initialization parameter file; determines whether the source system is expected to create the data file based on parameters from the entry; watches for the data file from the source system based on the determination; receiving an indication from the source system that the data file is available for transfer; selects an entry in the first initialization parameter file based on the indication; acquires a plurality of parameters from the selected entry; and retrieves the data file from the source system according to a processing strategy based on the parameters from the selected entry; and
a processor that runs the program.

41. An apparatus for managing data files transferred from a source system, comprising:
a memory having a program that: receives an indication from the source system that a data file is available for transfer; selects an entry for the data file in a first initialization parameter file based on the indication; acquiring a plurality of parameters from the selected entry; retrieves the data file from the source system according to a processing strategy based on the parameters; requests to save the retrieved data file in a global list file; accesses the global list file to save the retrieved data file; determines whether all of the data files needed to execute a job are available in the global list file; provides the needed data files to the job once the needed data files are available; and executes the job; and
a processor that runs the program.

42. An apparatus for managing data files transferred from a source system, comprising:
a memory having a program that: receives a signal file from the source system indicating that a data file is available for transfer; selects an entry for the in a first initialization parameter file based on contents of the signal file; acquires a plurality of parameters from the selected entry; retrieves the data file from the source system according to a processing strategy based on the parameters; and sends a request to a global manager to save the retrieved data file in a global list file; and
a processor that runs the program.

43. A system for managing data files in a network, comprising:
a plurality of source systems; and
a server that maintains a first initialization parameter file and a second initialization parameter file, the server operable to read an entry corresponding to a data file from the second initialization parameter file; determine whether one of the source systems is expected to create the data file based on parameters from the entry; watch for the data file from the one source system based on the determination; receive an indication, from the source system expected to create the data file, that the data file is available for transfer; select an entry in the first initialization parameter file based on the indication; acquire a plurality of parameters from the selected entry; and retrieve the data file from the source system according to a processing strategy based on the parameters from the selected entry.
